(19) United States
(12) Patent Application Publication
(10) Pub. No.: US 2009/0070178 A1
(43) Pub. Date: Mar. 12, 2009

(54) System and method for scheduling and confirming appointments

(76) Inventor: Charise Kay Gilbert, Salt Lake City, UT (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 11/900,516

(22) Filed: Sep. 11, 2007

(51) Int. Cl. G06Q 10/00

(52) U.S. Cl. 705/8

(57) ABSTRACT

A system and method are disclosed to allow scheduling of viewing and service appointments over a network. A user accesses the system over the network and views a plurality of time slots corresponding to a real estate property or corresponding to a service appointment. Upon user selection of a time slot, an electronic request is sent for the selected time slot.

This disclosure relates generally to communication systems and specifically to systems and methods for transmitting information between individuals and entities to establish appointments.

### BRIEF DESCRIPTION OF THE DRAWINGS

FIG. 1 is a block diagram of an embodiment of a system for scheduling appointments.

FIG. 2 is an exemplary embodiment of a graphical user interface user to input destinations for electronic requests.

FIG. 3 is an exemplary embodiment of a graphical user interface to request appointments.

FIG. 4 is another exemplary embodiment of a graphical user interface to request appointments.

FIG. 5 is an exemplary embodiment of a queue to display scheduled appointments.

FIG. 6 is an exemplary embodiment of a property list that may be associated with a listing agent.

FIG. 7 is an exemplary embodiment of a settings webpage to input settings for responding to appointment requests.

FIG. 8 is an exemplary embodiment of a list of buyers associated with a listing agent.

FIG. 9 illustrates an embodiment of an exemplary graphical user interface to solicit user feedback.

### DETAILED DESCRIPTION OF PREFERRED EMBODIMENTS

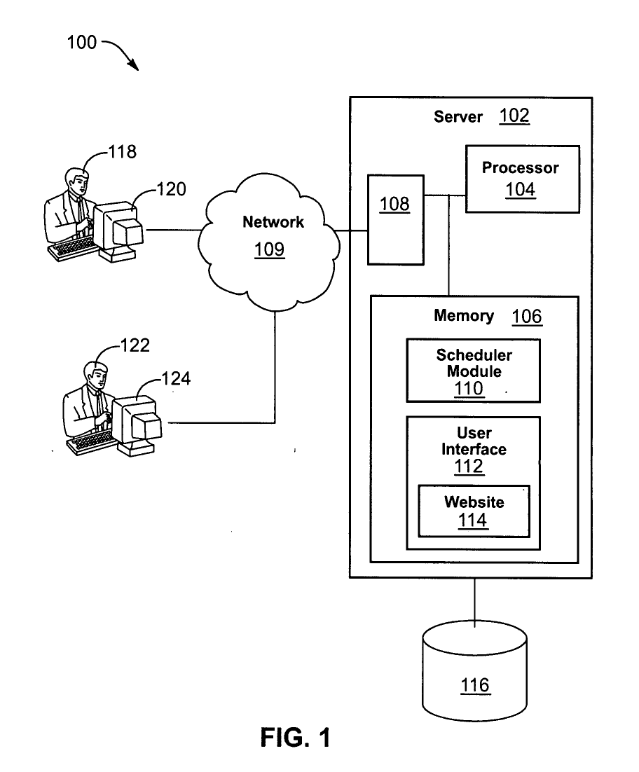

The embodiments of the disclosure will be best understood by reference to the drawings, wherein like parts are designated by like numerals throughout. It will be readily understood that the components, as generally described and illustrated in the Figures herein, could be arranged and designed in a wide variety of different configurations. Thus, the following more detailed description of the embodiments of the apparatus, system, and method of the disclosure, as represented in FIGS. 1-9, is not intended to limit the scope of the disclosure, as claimed, but is merely representative of possible embodiments of the disclosure.

For convenience, reference is also made to users, agents, service provider and humans to distinguish them from the automated functions disclosed herein. But a user, agent, or service provider may be any legal person, such as an individual, corporation, limited liability company, foundation, or partnership. Also, the disclosed system is presumably programmed, built, or otherwise created and/or maintained by people according to teachings herein. Operation of the system and method may be overseen by human administrators and driven by data and/or commands from human users. The system may also be property of an individual, corporation, or other legal person.

Much of the infrastructure that can be used according to the present invention is already available, such as: general purpose computers; computer programming tools and techniques; computer networks and networking technologies; wireless communication; email and text messaging; and digital storage media.

Suitable networks for configuration and/or use as described herein include one or more local area networks, wide area networks, metropolitan area. networks, and/or “Internet” or IP networks such as the World Wide Web, a private Internet, a secure Internet, a value-added network, a virtual private network, an extranet, an intranet, or even standalone machines which communicate with other machines by physical transport of media. In particular, a suitable network may be formed from parts or entireties of two or more other networks, including networks using disparate hardware and network communication technologies. A network may incorporate land lines, wireless communication, and combinations thereof.

The network may include communications or networking software such as the software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. The network may encompass smaller networks and/or be connectable to other networks through a gateway or similar mechanism.

One suitable network includes a server and several clients; other suitable networks may contain other combinations of servers, clients, and/or peer-to-peer nodes, and a given computer may function both as a client and as a server. Each network includes at least two computers such as the server and/or clients. A computer may be a workstation, laptop computer, disconnectable mobile computer, server, mainframe, cluster, so-called “network computer” or “thin client”, mobile telephone, personal digital assistant or other hand-held computing device, “smart” consumer electronics device or appliance, or a combination thereof.

Each computer may include a processor such as a microprocessor, microcontroller, logic circuitry or the like. The processor may include a special purpose processing device such as an ASIC, PAL, PLA, PLD, Field Programmable Gate Array, or other customized or programmable device. The computer may also include a memory such as non-volatile memory, static RAM, dynamic RAM, ROM, CD-ROM, disk, tape, magnetic, optical, flash memory, or other computer storage medium. The computer may also include various input devices and/or output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

Aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

The software modules tangibly embody a program, functions, and/or instructions that are executable by computer(s) to request, schedule, and confirm appointments as described herein. Suitable software to assist in implementing the invention is readily provided by those of skill in the pertinent art(s) using the teachings presented here and programming languages and tools such as XML, Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

In many industries, business interaction and in particular customer satisfaction is highly dependent on successfully making, confirming, and honoring appointments. Only a few examples of these include, real estate property showings, medical and dental appointments, automobile repair appointments, parent/teacher conferences, counseling, home lawn and appliance repair, office equipment repair and maintenance, and the like. Current methods for establishing service appointments rely on telephone exchanges which are highly inefficient and may involve the wasteful exercise of “telephone tag.” Furthermore, reminders for scheduled appointments may require a user to enter the appointment into a planner which is unreliable as a user may not remember to perform this action. Reminders may also rely on post cards which are often discarded.

A particular application is in the real estate industry where listing agents and buyer agents communicate regularly to set up viewing appointments to look at real estate properties for sale. Often times establishing viewing appointments is frustrating and involves a waste of time as both the buyer agent and the listing agent attempt to contact each other and establish a mutually agreeable time. Most agents rely on telephone calls, voice messages, emails, and text messaging in attempts to contact one another during hectic days. Buyer agents experience a number of frustrations including calling listing agents and only getting voice mail, listing agents that never call back, listing agents that need to verify show times before calling back, an occupied listing agent telling the buyer agent to call back and leave your number on voicemail, and other communication delays. Listing agents experience the frustrations of buyer agents that wish to chat excessively, a buyer agent trying to sell the buyer qualifications to the listing agent, a buyer agent wanting the listing agent to call the buyer agent, receiving the buyer agent's voice mail, talking to a buyer agent who does not remember the property address, and the like.

In establishing a viewing appointment it takes at least two to three telephone calls as a buyer agent calls a listing agent, the listing agent calls the property seller, and the listing agent then calls back the buyer agent. In actual practice, it can take many more communications before a viewing appointment is confirmed. As real estate agents only receive compensation when homes are sold, lost time in placing additional calls becomes unduly burdensome.

Agents further exchange information on properties such as which properties are available for viewing, when the properties are available for viewing, how many times a property has been shown to prospective buyers, price listings, appraisals, pictures, feedback on the property, feedback specific to a viewing experience, and any additional information or developments specific to a property. The systems and methods disclosed below eliminate much of the real estate agents'wasted time and facilitates appointment scheduling and enhances communication. As described herein, a feedback report may be generated which compiles comments from buyer agents who have viewed a property. The feedback report may be sent periodically to a listing agent and client such as on regularly scheduled intervals or when updated. In addition to comments, the feedback report may include information on the number of electronic requests to view a property, the number of confirmed viewing appointments, the number of actual viewing appointments, the number of buyer agents responding to feedback requests and providing feedback comments, and so forth. As can be appreciated by one of skill in the art, the feedback report may be configured in a variety of ways to provide valuable marketing information to the buyer agent and client. Indeed, the feedback report may include general market information regarding market performance in an area, recent sales in an area, and so forth. As with other electronic messaging disclosed herein, the feedback report may be transmitted electronically and conveniently viewed by desktop, laptop, or by portable handheld devices.

Referring to FIG. 1, a block diagram of an embodiment of a scheduling system 100 is shown. The system 100 is configured for scheduling viewing appointments of real estate properties. A server 102 includes a processor 104, a memory 106, and a network interface 108. The network interface 108 enables communication with a network 109 which, as discussed above, may include the Internet. A scheduler module 110 is resident on the memory 106 and provides the engine to enable users to schedule appointments over the network 109. A user interface 112 may also be resident on the memory to provide a website 114, including webpages, and graphical user interfaces. The server 102 may be in electrical communication with one or more databases 116 that store information on various real estate properties. In one embodiment, the database 116 may be resident within the server 102 or accessed remotely. One of skill in the art will appreciate that additional hardware and/or software components may be incorporated into the system.

A buyer agent 118 or requesting user accesses the server 102 over the network 109 through a computer device 120. Instead of a buyer agent, the requesting user 118 may be a home appraiser, insurance agent, service provider, or other human entity who wishes to gain access to a real estate property. The computer device 120 may be a desktop computer, laptop computer, blackberry, cellular telephone other portable hand-held computing device. Through the computer device 120, the buyer agent 118 may establish an account with the scheduler module 110. Alternatively, the scheduler module 110 may not require an account for participation. In establishing an account, the buyer agent 118 may access an account setup webpage and enter user information to enable registration and participation. An account may require a user name and/or password. In one embodiment, a user name and password for another organization may be used. For example, if the buyer agent 118 is a member of a Multiple Listing Service (“MLS”), the same log-in information may be used.

Once registered or logged-in, a buyer agent or requesting user 118 may make a request for a viewing appointment for a real estate property. The viewing appointment may include showing the property to prospective buyers, evaluating the property for appraisal, evaluating the property for insurance, estimating damages to the property for insurance, providing services to the property, and the like. The user interface 112 may provide a request webpage where the buyer agent 118 enters property information to identify the desired real estate property. The property information may include a MLS number, an address, or other unique information. Based on the property information, the scheduler module 110 searches the database 116 for a file corresponding to the desired real estate property.

Once the server 102 receives the property identity, time, and date information, it may access and search the database 116, archive, other website, or other data storage device to retrieve property information corresponding to the property. The property information may include the listing agent for the property, contact information for the property, facts about the property, pictures of the property, listing price, lockbox codes, combinations for entry, special instructions regarding home etiquette, pet warnings, or any other information critical or unique to the property.

The server 102 then generates an electronic request to the corresponding listing agent(s) 122. The listing agent 122 includes any individual, group of individuals, organization, or other legal entity that is involved with the listing and sale of the property. The listing agent 122 may also be referenced herein as the property user. The listing agent 122 authorizes the use of the system 100 to access and schedule viewing appointments. The listing agent 122 views a displayed electronic request through a computer device 124. The computer device 124 may be any one of the devices discussed above in reference to the computer device 120.

The electronic request may comprise email, text message, or other digitally stored and computer displayable message. The electronic request includes an identification of the property and a time and date for a viewing appointment. The scheduler module 110 retrieves from memory or from the database 116 the email, telephone number, IP address, or other destination corresponding to the listing agent 122. The server 102 then transmits the electronic request to the destination. The electronic request may be sent via email, phone text, pager, or any other text-based system. The electronic request may be sent using any one of a variety of communication protocols including IP, TCP/IP, Wifi, Imax, and the like.

The electronic request may be displayed on the computer device 124 for viewing by a listing agent 122. Upon reviewing the property identification and the time and date of the proposed viewing appointment, the listing agent 122 may decide whether to accept or decline the proposed viewing appointment. The computer device 124 may be used to generate an electronic response indicative of an acceptance or rejection of the proposed viewing appointment. The electronic response is transmitted to the server 102. The electronic response may include the above discussed property information about the property to facilitate a viewing appointment. The property information may be previously entered and stored by the server 102. When the electronic response is received by the server 102, the server 102 may include the property information. In one embodiment, the server 102 only includes the property information if the electronic response is an acceptance of the request. Alternatively, a listing agent 122 may enter property information through the computer device 124 when responding to the electronic request. The listing agent 122 may further provide comments to the electronic response. The comments may be entered by the listing agent 122 when responding to an electronic request. Alternatively, the comments may be previously stored at the server 102 and automatically inserted into an electronic response.

The electronic request may include a link with an “accept appointment” option and a link with a “decline appointment” option. If the listing agent 122 selects “accept appointment” or “decline appointment” the server 102 receives a response indicating an acceptance or rejection of the proposed viewing appointment.

In one embodiment, the listing agent 122 is able to select an “other” option in addition to accept and decline. If the listing agent 122 selects “other” then the listing agent 122 may send a text message to the buyer agent 118 and provide additional information. The additional information may be transmitted through the server and forwarded to the buyer agent 118. The additional information may include conditions to a viewing appointment or suggest another time for a viewing appointment. A buyer agent 118 may respond to the listing agent 122 and transmit an electronic message through the server 102 which is then directed to the listing agent 122.

When an electronic request is initially sent to a listing agent 122, the server 102 may start a timer. If the listing agent 122 fails to respond within a predetermined amount of time, the server 102 may generate an electronic message to the buyer agent 118 that the listing agent 122 is non-responsive. The server 102 may also automatically resend a predetermined number of additional electronic requests until the listing agent 122 responds or until the server 102 sends the full predetermined number of electronic requests. If a listing agent 122 fails to respond to any or all of the electronic requests, then the server 102 may retrieve other contact information for another user corresponding to the property. The electronic request may then be sent to this second user. The second user may be another agent, associate, or may even be the owner of the property. Rather than terminating attempts to set a viewing appointment, the system 100 may always default to sending an electronic request to the property owner.

After the time of a confirmed viewing appointment has passed, the server 102 may generate a feedback message and send it to the corresponding buyer agent 118. This message requests information about the viewing appointment, such as buyer interest, property ratings, follow up questions on the property, or any general comments by either the buyer or buyer agent.

The server 102 may forward the electronic response, whether acceptance or rejection of the proposed viewing appointment, to the buyer agent 118. The server 102 may also generate an electronic message indicative of the electronic response and transmit this message to the buyer agent 118. The server 102 may also store the electronic response in memory 106 and maintain a record of confirmed or denied viewing appointments.

The server 102 may maintain a buyer agent appointment queue which may list the status of viewing appointments. The status of viewing appointments includes the status of proposed viewing appointments and confirmed viewing appointments. Upon receiving a response from a listing agent 122, the server 102 may automatically update the buyer agent appointment queue to reflect a confirmed viewing appointment. As can be appreciated, denied appointments need not be tracked in a buyer agent appointment queue. Thus, concurrent with transmitting an electronic message to the buying agent 118, the buyer agent appointment queue is updated. A buyer agent 118 may access the server 102 and call up the buyer agent appointment queue and review upcoming and even past viewing appointments. The appointment queue may list viewing appointments with the time, date, property identification, and address. The appointment queue may also provide a link to a map application to facilitate travel to the property.

In one embodiment, a buyer agent 118 may also seek to modify requested or confirmed viewing appointments in the buyer agent appointment queue. A buyer agent 118 may request a different time and/or date for viewing appointment. This may be done by selecting a displayed viewing appointment and then selecting an option, through a graphical user interface, to request another time and date. Alternatively, a buyer agent 118 may select and move the confirmed viewing appointment to another location in a displayed calendar. An electronic request may then be generated by the server 102 and transmitted to a listing agent 122 in a manner similar to that described above. The listing agent 122 is then at liberty to accept or decline the new electronic request.

A buyer agent 118 may also select a confirmed viewing appointment from the queue and have the option to delete the viewing appointment. The buyer agent 118 has the ability to select an individual confirmed viewing appointment for deletion or multiple confirmed viewing appointments for deletion. A comments input, such as a pop-up window or other associated text box, may be provided to allow a buyer agent 118 to enter comments explaining the deletion. The reasons for deletion may include any number of explanations such as sudden emergency, the buyer is no longer on the market, etc. The comments may also include a request to the listing agent to reschedule a viewing appointment. Upon deletion, an electronic message is transmitted to the listing agent 122 to inform the listing agent 122 of the cancellation. The electronic message may include the submitted comments from the buyer agent 118.

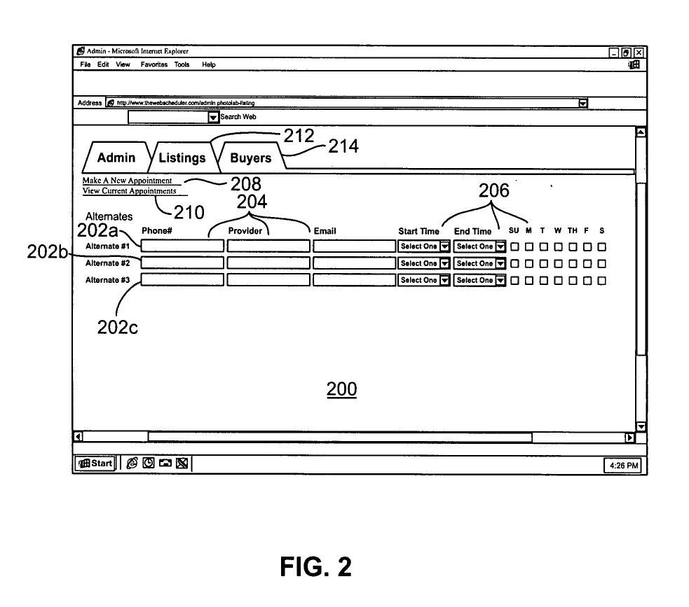

Referring to FIG. 2, an embodiment of an administrative webpage or other graphical user interface 200 is shown. As embodied webpage 200, a user may access the administrative webpage 200 using appropriate browser software. After logging in, a property user 122 may access the administrative webpage 200 which may be embodied in a variety of ways as FIG. 2 is provided for exemplary purposes only. After verification of the user, the server 102 allows access to an account corresponding to property user 122. The administrative webpage 200 may be accessed from a menu page or is provided after log-in. The administrative webpage 200 provides one or more contact inputs 202a-c which will receive electronic requests. The contact inputs 202a-c may provide destination input windows 204 for a phone number, network provider, email address, and the like. The destination input windows 204 receive destinations to which electronic requests will be sent. A listing agent 122 may enter contact information for the owner of a property as well. Alternatively, an owner may automatically be included as a possible contact. Owner contact information, which may be stored and associated with a property, may be retrieved and used to contact an owner if needed.

Each contact input 202a-c may also include corresponding time and day input 206. Thus, a destination may be designated for a time interval commencing at a start time and ending at an end time for designated days of the week. Each contact input 202a-c may correspond to different human users or may correspond to different destinations for the same human user. For example, a human user may be available at one destination on weekdays and at a different destination on weekends. Alternatively, a first human user may be available at an indicated destination on weekdays and a second human user may be available at another indicated destination on weekends. By selecting the times and days, the inputted destinations receive the electronic requests and associated correspondence. If desired, multiple destinations may be selected to receive the electronic requests at the same time.

As discussed herein, if an electronic request is sent to a listing agent 122 and the listing agent 122 does not respond after repeated attempts or after a certain time, the electronic request may be sent to another listing agent 122, property owner, or contact. The contact input 202a-c allows the server 102 to send an electronic request to other destinations when a first recipient fails to respond. Settings and defaults may be established for the preferential order in which other destinations are selected to receive an electronic request. In one embodiment, a property owner always receives an electronic request before responding to a buyer agent 118 that the system 100 terminates attempts to set a viewing appointment.

The administrative webpage 200 may further include a link 208 to request a new viewing appointment, a link 210 to view current viewing appointments, a link 212 to view listings associated with a listing agent 122, and a link to view buyers 214 associated with the property user or listing agent 122.

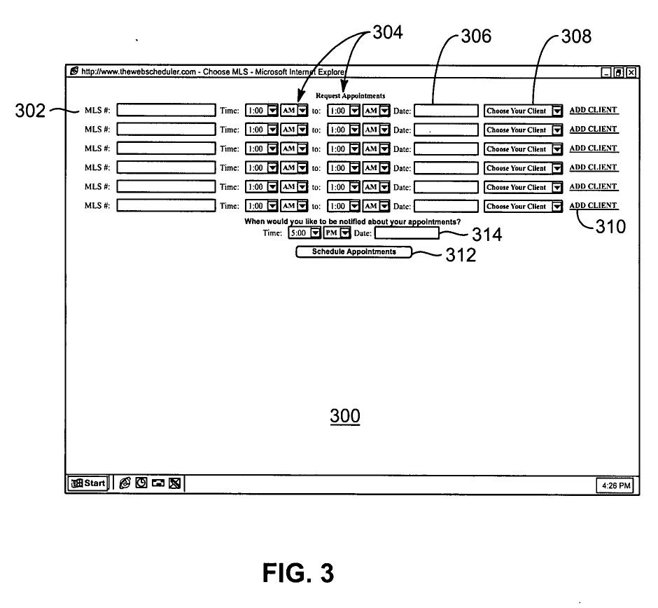

Referring to FIG. 3, an embodiment of a request webpage 300 for requesting a new viewing appointment is shown. The request webpage 300 may be accessed from after log-in from a main menu, from the link 208, or any other links provided by the server 102 to facilitate navigation. The requesting user 118, who in other circumstances may also be designated as a property user or listing agent 122, enters property identification information for a desired real estate property in a property identification input 302. The property identification may be a MLS number such as is commonly used in the industry. Alternatively, the property identification may be another number or even a street address to provide a unique identification of the desired property.

The user 118 may also enter a desired time window for viewing a real estate property in a corresponding time input 304. A date input 306 is further provided to enter the corresponding date. The request webpage 300 may also include a client input 308 to enter the name of the client that will be viewing the real estate property. The client input 308 may allow a selection of existing clients corresponding to the requesting user 118. The request webpage 300 may also provide an add client link 310 to add a new client. Addition of new client information may be stored in the memory 106 or database 116 for future access and retrieval.

The request webpage 300 may include a “Schedule Appointments” input 312. When the Schedule Appointments input 312 is clicked or otherwise entered, the entered information is processed by the server 102 and an electronic request is generated and sent to a property user 122. The request webpage 300 may further include a notification input 314. The notification input 314 allows a user to enter when they wish to be notified of acceptance or rejection of an electronic request. A requesting user 118 may, for example, wish to be notified at a certain time of the day. In this way, a user 118 may access email at the desired time and review appointments for the next day. Alternatively, the server 102 may immediately send responses to electronic requests.

As shown, the request webpage 300 may include multiple property identification inputs 302 and corresponding time, date, and client inputs 304, 306, 308, and 310. A requesting user 118 may thereby make multiple requests through a single webpage interface.

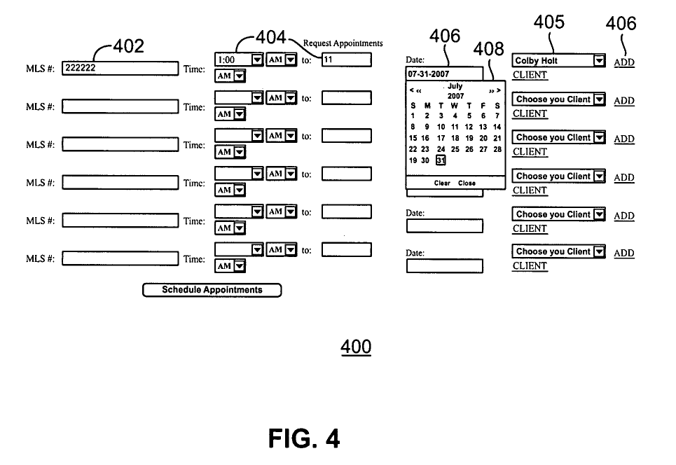

Referring to FIG. 4, an embodiment of a request webpage 400 is shown with entered property identification 402, time interval 404, and date 406. The date input may be configured to display a calendar 408 for easy and quick date selection. The client name 410 may also be entered and this client is associated with the electronic request.

After the server 102 receives the property identification, time, and date, the server 102 generates an electronic request to the corresponding property user 122. The electronic request may be sent to any one of the destinations provided through the administrative webpage 200. The property user views a displayed electronic request through the computer device 120 as describe above.

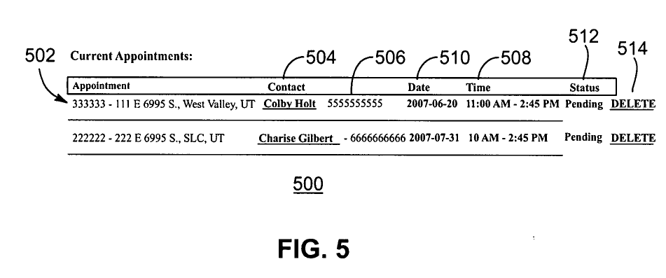

Referring to FIG. 5, an embodiment of a buyer agent appointment queue 500 is shown which displays a list of requested viewing appointments and their current status. The queue 500 may be accessed through a main menu or other links provided by the server 102 and may be viewed through a web browser or other applications capable of displaying graphical user interfaces. The information displayed in the queue 500 may include property identification 502 and a corresponding contact 504, such as the property user. The contact's telephone number may also be displayed 506 if desired for follow up communication if needed. The requested time 508 and date 510 may also be displayed. The status 512 of the appointment may also be listed to indicate whether the viewing appointment has been accepted, declined, or if its still pending. Furthermore, the queue 500 may be configured to include an option 514 to modify or delete any requested or confirmed appointment. In the illustrated embodiment, the user 118 is provided with a delete option 514 which allows a user 118 to terminate the requested or even confirmed viewing appointment. Upon deletion, an electronic message is sent to the property user to inform the property user of the deletion.

In addition to managing a current listing of all the buyer agent's upcoming appointments, the server 102 may also generate and send a daily reminder message to the buyer agent 118. The daily reminder message informs the buyer agent 118 of the day's confirmed viewing appointments. The daily reminder message may also include an option to select or otherwise link to the buyer agent appointment queue.

The queue 500 may include a link to a web application for finding directions to any property. Such a link may be conveniently disposed on any graphical user interface provided by the server 102 as desired to facilitate travel.

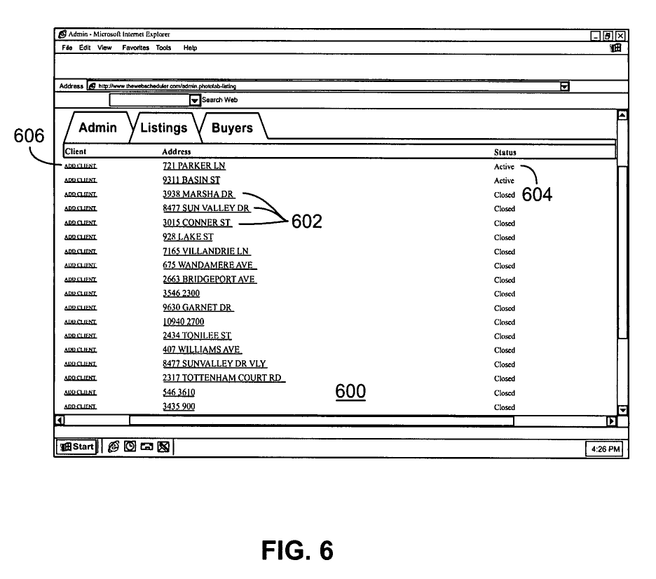

Referring to FIG. 6, an embodiment of a listings webpage or graphical user interface 600 is shown. The listings webpage 600 may be accessed through a main menu, a link 212, or other link in a user interface. The listings webpage displays the listings of real estate properties associated with a user. The listings may identify each real estate property by a street address, MLS number, or other unique identifier. As can be appreciated, a user participating in the system 100 may have listed properties whether or not a user is designated as a buyer agent 118 or a listing agent 122 for a particular request. The listings webpage 600 allows a user to review corresponding listings 602 and see their associated status 604. The status 604 may indicate “active,” for properties that are currently on the market and under contract with an agent, “under contract” for properties that have an accepted offer, and “closed” for properties that are no longer available for sale.

Each listed property 602 may have a corresponding client link 606 which allows a user to add a client. The client is thereafter associated with the listed property 602. By clicking or otherwise selecting the client link 606, a user may be directed to a client webpage where the user insert client information, update client information, or review client information. The client information may include contact information, profile information, or any other information associated with a client.

Each listed property 602 may include a link to a settings webpage or other settings user interface to allow a user to establish and modify certain settings associated with a listed property 602. For example, by clicking or otherwise selecting the unique identification of a listed property 602, such as the address, the browser, or other application displays the settings webpage. Alternatively, a separate link for the settings webpage may also be displayed in relation to a listed property 602.

Each listed property 602 may include a link to view, revise, or enter property information specific to the property. The property information may be stored by the server 102 and transmitted with a response to an electronic request. The property information may include information in addition to the unique identification of the property.

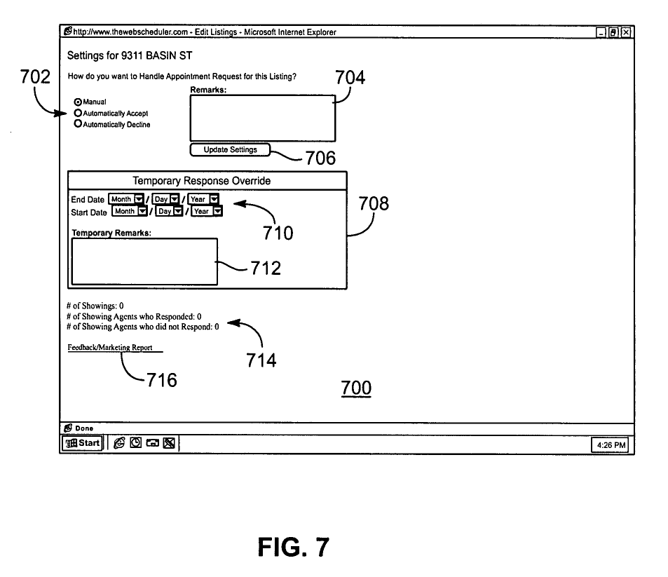

Referring to FIG. 7, an example of a settings webpage 700 is shown. The settings webpage 700 may include electronic request management input 702 which determines how electronic requests are to be handled. For example, a listing agent 122 may select the “manual” option to indicate that all electronic requests are to be delivered to the appropriate destinations and the listing agent 122 will manually respond to each electronic request. The destinations may be established through the administrative webpage 200. Alternatively, the settings webpage 700 may be configured to receive and store destinations for electronic requests in a manner similar to the administrative webpage 200.

A listing agent 122 may also select the management input 702 to be an automatic acceptance for each received electronic request for the corresponding property. In so doing, a listing agent 122 will still receive an electronic notification of the viewing appointment, but the listing agent 122 will not have an opportunity to decline the electronic request. A listing agent 122 may also select the management input 702 to automatically decline each received electronic request for the corresponding property. If selected, a listing agent 122 may receive an electronic notification of an electronic request, but the listing agent 122 will not be able to accept the electronic request. As can be appreciated by those in the industry, the automatic acceptance and rejections of electronic requests may be very useful in certain circumstances. For example, a property may be in a temporary condition where it may not be shown. Alternatively, a property may have an open house for period of time and all agents are welcome to come.

The management input 702 may have a comments input 704 to receive, store, and display user comments. The user comments may accompany any manual response to an electronic request. The user comments may explain why the management input has been set to automatic accept or automatic decline. These user comments may be transmitted with an automated response to an electronic request. The management input 702 may include an update settings input 706 which allows a listing agent 122 to confirm the settings. Alternatively, the settings may be established automatically when a listing agent exits from the settings webpage 700.

The settings webpage 700 may further include a temporary response override input 708 which establishes a time frame for temporary and automatic response for electronic requests for the corresponding property. The override input 708 may include start and end input 710 for the start date and end date for the temporary, automatic response. By inserting start and end input 710, the time frame for automatic acceptance and decline in input 702 may be established. The override input 708 may include a temporary remarks input 712 which allows a listing agent 122 to insert remarks associated with the temporary override. For example, temporary remarks may state that the property is having the carpeting replaced and is not available until a certain time. The temporary, automatic response may include a variety of responses for a desired time period. When the end time and/or date in input 710 is reached, the temporary automatic responses cease as the override “ages off.” Delivery of electronic requests may thereafter default to settings established in the administrative webpage 200 with electronic requests being delivered to the inputted destinations. In one example, a listing agent 122 may set an automatic decline in input 702 with the remarks that the carpets are being cleaned and please reschedule after October 20^{th}. The listing agent 122 may then enter start and end input 710 with the end input corresponding with October 20^{th}. Once October 20^{th} is reached, then the automatic decline and accompanying remarks terminate and electronic requests are delivered to destinations provided in the administrative webpage 200.

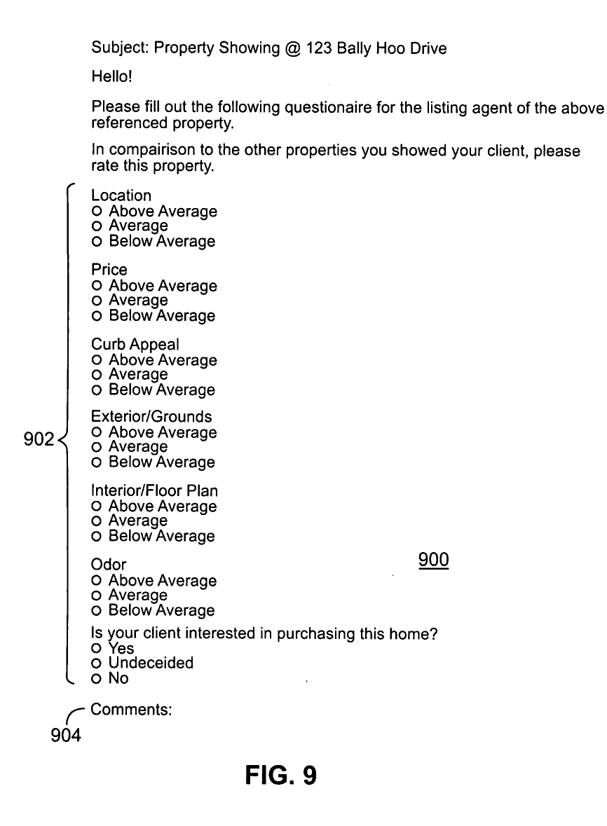

The settings webpage 700 may also include and display appointment information 714 for the property such as the confirmed number of viewing appointments, the number of buyer agents responding to feedback requests, and the number of buyer agents who did not respond to feedback requests. The settings webpage 700 may further include a feedback report link 716 which directs a listing agent 122 to a feedback report specific to the corresponding property. The feedback report is discussed further below in reference to FIG. 9 and includes information on viewing appointment experiences with the property.

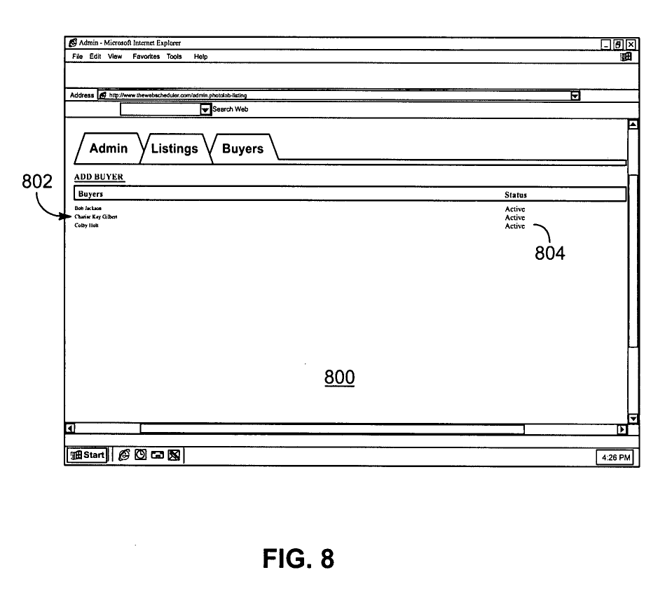

Referring to FIG. 8, a buyer webpage or buyer graphical user interface 800 is shown. A buyer agent 118 may access the buyer webpage 800 through a menu or any other appropriate link after logging into the server 102. The buyer webpage 800 displays buyers 802 associated with the logged-in buyer agent 118. The buyer webpage 800 provides a convenient location for a buyer agent 118 to review buyers 802 who are in the market for a property. For each buyer 802, an associated status 804 may be displayed to indicate whether a buyer 802 is active or closed. An active buyer 802 is currently looking to purchase a property whereas a closed buyer 802 is no longer looking to purchase a property. By clicking or otherwise selecting a buyer 802, the associated buyer information may be displayed. Buyer information may be displayed in another browser window or may be displayed on the buyer webpage 800. The buyer information may include contact information and other information such as property preferences, area preferences and a list of properties previously shown to the buyer.

Referring to FIG. 9, an example of a feedback request 900 is shown. The feedback request includes a plurality of response options 902 and may be configured in a variety of formats to facilitate receipt of constructive feedback. In addition to or instead of providing predetermined response options, the request 900 may provide for typed comments 904 to facilitate information gathering.

The buyer agent 118 may complete and send a response to the feedback request 900 to the server 102. If the buyer agent 118 fails to respond within a predetermined time, the server 102 can generate and issue a set number of additional feedback requests or notices. After that number, if the buyer agent 118 still declines to respond, the server 102 can store a “no response” or similar message in place of feedback.

Over the course of multiple viewing appointments, the server 102 may track and store the number of confirmed viewing appointments that a property receives and the feedback provided through a feedback request 900. Feedback information may be stored in a log in memory 106. At a predetermined time, the server 102 may generate a feedback report based on the information contained in the log. A feedback report is sent to a corresponding listing agent 122 and can be compared with feedback reports from prior periods. Feedback reports can also include comparisons with similar homes in the region, based on information in the log and the database 116, and can present the information graphically or textually.

Referring again to FIG. 1, the system 100 may also be used to schedule service appointments with application to a wide variety of service providers. The scheduled services may be those that require a user, such as a customer, client, or patient, to physically visit a service provider's office. Examples of these include medical, dental, physical therapy, automobile service and repair, and the like. The scheduled services may require that the service provider visit the user's residence or office. Examples of these include pest control, home service and repair, home and office appliance service and repair, and the like.

For service appointments, the requesting user 118, instead of being a buyer agent or the like, is a customer, client, or patient. The property user 122 is now designated as a service provider. The server 102 may be embodied in a manner similar to that described above. The scheduler module 110 provides a core engine for performing the functions as described herein to schedule service appointments.

As in previous embodiments, the service provider 122 may use a computer device 124 to view and respond to electronic requests. This is particularly useful where the service provider 122 travels throughout the day. For example, a service provider 122 that provides residential services may view a cellular telephone, PDA, blackberry and the like and note an electronic request for a service appointment. The service provider 122 may confirm availability with a schedule and then respond. The schedule may be in a hard copy format or may be in an electronic format and may even be resident on the computer device 124. A schedule application may interface with and process the electronic request to determine if there is availability during a work schedule.

The electronic request displayed to the service provider 122 may indicate the request and state that the requested time slot is available or that the requested time slot conflicts with another appointment. If there is a conflict, the service provider 122 may consider overriding the previous appointment. This may be useful when the requested appointment is a higher priority than the previously scheduled appointment.

In an alternative embodiment, the service provider 122 may access the server 102 or a computer device networked to the server to view electronic requests and to respond. For example, the service provider 122 may be a dental office and a user may view an electronic request at the office. Dentists, and like professionals, typically remain at their office to render the services. The user may respond to the requesting user 118 in a manner similar to that described above but by using a desktop computer device rather than a portable computer device. In this way, a service provider 122, which includes the office staff for a service provider 122, may receive, review, and accept or decline requests for service appointments.

As can be appreciated, the graphical user interfaces disclosed above may be modified to accommodate the nature of the professional service. In one embodiment, a requesting user 118 may access a service webpage or other similar graphical user interface to select a desired service. For example, a requesting user 118 may select oil change, tire rotation, flat repair, etc. The time slots available may depend on the service selected. For example, all automotive bays for an oil change may be occupied for a desired day, but an automotive bay dedicated to tire service may be available in the afternoon on that day. The length of time required for the service may also depend on the nature of the service. For example, performing an oil change may take less time than a tune up and a service provider 122 will want to allocate sufficient time for the service. Service selection is not utilized if the service provider 122 only wishes to offer one service through use of the system 100.

The requesting user 118 may access a request webpage similar to that described above. The request webpage may allow the requesting user 118 to select a time and date for a service appointment. In one embodiment, the request webpage may display current available time and dates for the desired service. Previously confirmed service appointments may be stored in the server 102 and may be considered as unavailable for requested service appointments. As can be expected, service appointments may be provided simultaneously depending on the nature of the facilities, the type of service, and the number of service providers. For example, a dental office may accommodate multiple service appointments simultaneously. The anticipated length of the desired service may also be graphically displayed in a window with start and end times. A requesting user 118 is therefore only able to select available time and dates.

In an alternative embodiment, a requesting user 118 may be able to select time and dates for a service appointment. The scheduler module 110 then makes a determination as to whether the requested service appointment is available or not. As can be expected, previously confirmed service appointments may prevent scheduling of requested service appointments.

As the confirmed service appointment arrives, the server may send electronic reminders to the requesting user 118. The electronic reminders may even require a response from the requesting user 118 to confirm the service appointment. After a service appointment, the server 102 may generate and transmit a feedback request to solicit requesting user 118 feedback in a manner similar to that described above.

It will be obvious to those having skill in the art that many changes may be made to the details of the above-described embodiments without departing from the underlying principles of the invention. The scope of the present invention should, therefore, be determined only by the following claims.

1. A method to allow a requesting user to schedule viewing appointments over a network to thereby visit real estate properties, comprising:
providing a plurality of time slots accessible and displayable over the network, the time slots corresponding to a real estate property and indicative of potential viewing appointments;
upon requesting user selection of a time slot over the network, generating an electronic request to visit the real estate property at the selected time slot; and
transmitting the electronic request to a property user, the electronic request displayable to the user of the real estate property.

2. The method of claim 1, further comprising:
receiving over the network an acceptance of the electronic request from the property user; and
conveying over the network an acceptance of the electronic request to the requesting user.

3. The method of claim 2, further comprising storing a record of a viewing appointment corresponding to the accepted electronic request.

4. The method of claim 3, further comprising:
prompting the requesting user over the network for viewer appointment feedback;
receiving viewing appointment feedback over the network, the viewing appointment feedback indicative of the viewing appointment experience;
storing the viewing appointment feedback; and
displaying the viewing appointment feedback to the property user.

5. The method of claim 1, further comprising:
receiving from the property user a rejection of the electronic request; and
conveying over the network to the requesting user a rejection of the electronic request.

6. The method of claim 1, further comprising:
after transmitting the electronic request to a property user, waiting for a response from the property user for a time interval; and
upon not receiving a response from the property user during the time interval, transmitting the electronic request to a second property user.

7. The method of claim 1, further comprising establishing a queue of requested appointments corresponding to the requesting user, the queue indicating the status of the electronic request.

8. A system to allow a requesting user to schedule viewing appointments over a network to thereby visit real estate properties, comprising:
a network interface to enable communication with the network;
a processor coupled to the network interface; and
a memory coupled to the processor, the memory including computer executable code for performing a method comprising:
providing a plurality of time slots accessible and displayable over the network, the time slots corresponding to a real estate property and indicative of potential viewing appointments,
upon requesting user selection of a time slot over the network, generating an electronic request to visit the real estate property at the selected time slot, and
transmitting the electronic request to a property user, the electronic request displayable to the user of the real estate property.

9. The system of claim 8, wherein the method further comprises:
receiving over the network an acceptance of the electronic request from the property user; and
conveying over the network an acceptance of the electronic request to the requesting user.

10. The system of claim 9, wherein the method further comprises:
storing a record of a viewing appointment corresponding to the accepted electronic request;
prompting the requesting user over the network for viewer appointment feedback;
receiving viewing appointment feedback over the network, the viewing appointment feedback indicative of a viewing appointment experience;
storing the viewing appointment feedback; and
displaying the viewing appointment feedback to the property user.

11. The system of claim 8, wherein the method further comprises:
receiving from the property user a rejection of the electronic request; and
conveying over the network to the requesting user a rejection of the electronic request.

12. The system of claim 8, wherein the method further comprises:
after transmitting the electronic request to a property user, waiting for a response from the property user for a time interval; and
upon not receiving a response from the property user during the time interval, transmitting the electronic request to a second property user.

13. The system of claim 8, wherein the method further comprises establishing a queue of requested appointments corresponding to the requesting user, the queue indicating the status of the electronic request.

14. A method to allow a requesting user to schedule a service appointment with a service provider over a network, comprising:
providing a plurality of time slots accessible and displayable over the network, the time slots corresponding to potential service appointments by the service provider;
upon requesting user selection of a time slot over the network, generating an electronic request for the service appointment at the selected time slot; and
displaying the electronic request to the service provider.

15. The method of claim 14, further comprising upon acceptance of the electronic request by the service provider, conveying over the network an acceptance of the electronic request to the requesting user.

16. The method of claim 15, further comprising:
storing a record of a service appointment corresponding to the accepted electronic request;
prompting the requesting user over the network for service appointment feedback;
receiving service appointment feedback over the network, the service appointment feedback indicative of a service appointment experience;
storing the viewing appointment feedback; and
displaying the viewing appointment feedback to the property user.

17. The method of claim 14, further comprising upon rejection of the electronic request conveying over the network to the requesting user a rejection of the electronic request.

18. A system to allow a requesting user to schedule service appointment over a network, comprising:
a network interface to enable communication with the network;
a processor coupled to the network interface; and
a memory coupled to the processor, the memory including computer executable code for performing a method comprising:
providing a plurality of time slots accessible and displayable over the network, the time slots corresponding to potential service appointments by the service provider;
upon requesting user selection of a time slot over the network, generating an electronic request for the service appointment at the selected time slot; and
displaying the electronic request to the service provider.

19. The system of claim 18, wherein the method further comprises, upon acceptance of the electronic request by the service provider, conveying over the network an acceptance of the electronic request to the requesting user.

20. The system of claim 19, wherein the method further comprises:
storing a record of a service appointment corresponding to the accepted electronic request;
prompting the requesting user over the network for service appointment feedback;
receiving service appointment feedback over the network, the service appointment feedback indicative of a service appointment experience;
storing the viewing appointment feedback; and
displaying the viewing appointment feedback to the property user.

21. The system of claim 18, wherein the method further comprises, upon rejection of the electronic request, conveying over the network to the requesting user a rejection of the electronic request.

22. The system of claim 18, wherein the method further comprises transmitting over the network an update message to the requesting user, the update message including information on an upcoming service appointment.

23. A computer readable storage medium having stored thereon computer readable instruction code to perform a method to enable a requesting user to schedule viewing appointments over a network to thereby visit real estate properties, the method comprising:
providing a plurality of time slots accessible and displayable over the network, the time slots corresponding to a real estate property and indicative of potential viewing appointments;
upon requesting user selection of a time slot over the network, generating an electronic request to visit the real estate property at the selected time slot; and
transmitting the electronic request to a property user, the electronic request displayable to the user of the real estate property.

24. The computer readable medium of claim 23, wherein the method further comprises:
receiving over the network an acceptance of the electronic request from the property user; and
conveying over the network an acceptance of the electronic request to the requesting user.

25. The computer readable storage medium of claim 23, wherein the method further comprises:
receiving from the property user a rejection of the electronic request; and
conveying over the network to the requesting user a rejection of the electronic request.
